(19) United States
(12) Patent Application Publication
(10) Pub. No.: US 2026/0089802 A1
(43) Pub. Date: Mar. 26, 2026

(54) MULTINUMBERS TECHNOLOGY FOR WIRELESS SERVICES

(71) Applicant: Skytell AG, Zug (CH)

(72) Inventor: Felix Vakhovsky, Miami, FL (US)

(73) Assignee: Skytell AG, Zug (CH)

(21) Appl. No.: 18/891,576

(22) Filed: Sep. 20, 2024

(51) Int. Cl. H04W 76/40; H04W 4/14; H04W 4/16; H04W 88/06

(52) U.S. Cl. CPC H04W 76/40; H04W 4/14; H04W 4/16; H04W 88/06

(57) ABSTRACT

A multinumbers technology management system can include a multinumbers control point in a home network, a plurality of subscriber phone numbers stored on a memory of the multinumbers control point, and one or more processors configured to perform certain operations. The operations can include automatically selecting or manually selecting a calling subscriber's phone number corresponding to a phone number of a called party's country in a selection process, transmitting a phone number selected by the subscriber while establishing a connection to a called party or sending an SMS to a called party, if the subscriber does not have a phone number stored in the multinumbers control point corresponding to the called party's country, using a default number, and converting the subscriber's phone numbers to a primary phone number Home MSISDN if receiving calls or SMS messages at any of the plurality of subscriber phone numbers.

### CROSS-REFERENCE TO RELATED APPLICATIONS

Not applicable.

### TECHNICAL FIELD

The present disclosure generally relates to mobile station international subscriber directory number systems. More particularly, but not exclusively, the present disclosure relates to apparatus, systems, and methods that enables easy access to use many different local and international phone numbers using a single subscriber identity module SIM or eSIM.

### BACKGROUND

A mobile station international subscriber directory number (MSISDN) identifies a mobile subscriber and is used as a caller identification number when a phone call is placed from the mobile device. When a first user wants to call another mobile device user, the first user dials an MSISDN of the other party.

A single MSISDNs can be sent in this manner via a voice communication network, an short messaging service (SMS) network, a multimedia message service (MMS) network, or almost any other wired or wireless network. SMS and MMS networks are similar, but an SMS network is only capable of sending text whereas an MMS network can send multimedia content such as pictures, video, and audio in addition to text. Using MMS does require additional network infrastructure to process the additional data resulting from transmitting pictures, video and audio and typically requires an internet connection whereas an SMS text message does not. Typically, the internet connection for an MMS message is provided through cellular data networks.

With respect to MSISDNs, it is a technical term sometimes used for the mobile number attached to a SIM card or eSIM in a mobile phone. An MSISDN contains several significant numbers to identify country, destination, and subscriber number. Depending on the country, the MSISDN can generally be broken down like this:
MSISDN=CC+NDC+SN, where CC=Country Code, NDC=National Destination Code and SN=Subscriber Number.

In countries like the USA, an NDC is used to identify a specific region within the country, but some countries do not use an NDC. When sending SMS via SMPP, the number must be provided in full international format in order to deliver to the GSM network correctly. Many usability problems can surround this as a large proportion of mobile subscribers are not aware of specific country codes.

Notwithstanding the above, existing systems fail to provide ease of use and flexibility in a manner that is efficient and cost effective for both users and providers.

A glossary follows defining the terms and acronyms used in the industry and in this disclosure:
DID Provider is an operator that leases the MSISDN of various countries.
IMSI International Mobile Subscriber Identity.
Home Network Operator is the operator of the Home Network.
Home MSISDN is the MSISDN belonging to the Home Network Operator.
HLR Home Location Register.
GMSC is a Gateway Mobile Switching Center which is a type of Mobile Switching Center (MSC) that is used to route calls outside the mobile network. Mobile Switching Center Servers (MSC-S) provide control of high capacity switching in mobile circuit core networks for operators to control services and switching.
SMSC Short Message Service Center.
SBC is a session border controller is a dedicated hardware device or software application that governs the manner in which phone calls are initiated, conducted and terminated on a voice over Internet Protocol (VoIP) network. Phone calls are referred to as sessions. Note that a gateway mainly provides conversion between a circuit based interface and a packet based service while a SBC is the border between two packet-based networks. In a nutshell, SBCs play unique roles in a VoIP system and are indispensible for a well-functioning IP communication system.

### SUMMARY

In some embodiments, a multinumbers technology management system can include a multinumbers control point in a home network, a plurality of subscriber phone numbers stored on a memory of the multinumbers control point, and one or more processors coupled to the memory having computer instructions configured to perform certain operations. The operations can include automatically selecting or manually selecting a calling subscriber's phone number corresponding to a phone number of a called party's country in a selection process, transmitting a phone number selected by the subscriber while establishing a connection to a called party or sending an SMS to a called party, and converting the subscriber's phone numbers to a primary phone number Home MSISDN if receiving calls or SMS messaging to any of the plurality of subscriber phone numbers. If the subscriber does not have a phone number stored on the multinumbers control point corresponding to the called party's country, the control point will use a default MSISDN, which can be defined by the subscriber (manually) or by the control point automatically.

In some embodiments, the multinumbers technology management system further includes a subscriber identity module SIM or eSIM having the plurality of subscriber phone numbers associated with it. In some embodiments, the plurality of subscriber phone numbers are local phone numbers and international phone numbers. In some embodiments, the plurality of subscriber phone numbers associated with the SIM or eSIM are local phone numbers and mobile station international directory numbers (MSISDNs).

In some embodiments, the plurality of subscriber phone numbers are always active for calls and SMS messages.

In some embodiments, the multinumbers technology management system enables subscribers to select their preferred number type for their SIM card/eSIM. In some embodiments, the number types include mobile phone numbers with SMS support, landline phone numbers without SMS support, geographic-based phone numbers tied to a specific region, city, or location in a country, geographic-based national phone numbers that work throughout a country in any region of the country, virtual phone numbers, or toll-free numbers.

In some embodiments, the one or more processors enable the subscriber to add two or more phone numbers for a given country or region (such as the United States) to the SIM or eSIM to enable seamless use of connected local phone numbers for calls and SMS messages simultaneously.

In some embodiments, the one or more processors enable the subscriber to transfer and save all active phone numbers to a single SIM card/eSIM if the subscriber already has local or foreign phone numbers of different countries or regions (MSISDN).

In some embodiments, the subscriber receives all calls at a subscriber device having the subscriber identity module SIM or eSIM having the plurality of subscriber phone numbers associated with the SIM or eSIM without setting up call forwarding since the plurality of subscriber phone numbers are all active at the same time.

In some embodiments, the one or more processors enables the subscriber to simultaneously use multiple social media and messenger accounts on a subscriber device having the subscriber identity module SIM or eSIM having the plurality of subscriber phone numbers associated with the SIM or eSIM.

In some embodiments, the plurality of subscriber phone numbers are purchased by a subscriber.

In some embodiments, the one or more processors are further configured to perform the operations of receiving incoming calls by establishing a call with a network of a DID provider that leased the dialed MSISDN, routing the call by the DID provider to the network of an operator that leased the dialed MSISDN, sending the dialed MSISDN by the operator to the multinumbers control point for processing, converting the received subscriber's phone number to their Home MSISDN by the multinumbers control point, and establishing a connection to the called subscriber corresponding to the called subscriber's International Mobile Subscriber Identity (IMSI) and Home MSISDN.

In some embodiments, the one or more processors are further configured to perform the operations of sending outgoing calls by receiving an outgoing call in a subscriber's operator's network where an operator sends the outgoing call to the multinumbers control point for processing where the multinumbers control point converts a Home MSISDN into an MSISDN according to rules of the selection process where either automatic number selection or manual number selection by the subscriber is performed according to rules of the selection process, connecting the called party, and providing the phone number of the calling subscriber in accordance with the selection process.

In some embodiments, the one or more processors are further configured to perform the operations of receiving incoming SMS messages by establishing a SMS message with a network of a DID provider that leased the dialed MSISDN, routing the SMS message by the DID provider to the network of an operator that leased the dialed MSISDN, sending the dialed MSISDN by the operator to the multinumbers control point for processing, converting the received subscriber's phone number to their Home MSISDN by the multinumbers control point, and establishing a connection to the called subscriber corresponding to the called subscriber's International Mobile Subscriber Identity (IMSI) and Home MSISDN.

In some embodiments, wherein the one or more processors are further configured to perform the operations of sending outgoing SMS messages by receiving an outgoing SMS message in a subscriber's operator's network where an operator sends the outgoing SMS message to the multinumbers control point for processing where the multinumbers control point converts a Home MSISDN into an MSISDN according to rules of the selection process where either automatic number selection or manual number selection by the subscriber is performed according to rules of the selection process, connecting the called party, and providing the phone number of the SMS messaging subscriber in accordance with the selection process.

In some embodiments, a multinumbers control point in a telecommunication system can include a plurality of subscriber phone numbers stored on a memory of the multinumbers control point at a home network and one or more processors coupled to the memory having computer instructions for performing certain operations. The operations can include automatically selecting or manually selecting a calling subscriber's phone number corresponding to a phone number of a called party's country in a selection process, transmitting via a session border controller a phone number selected by the subscriber while establishing a connection to a called party or sending via a short message service center an SMS to a called party. If the subscriber does not have a phone number stored in the multinumbers control point corresponding to the called party's country, the multinumbers control point will use a default MSISDN, which can be defined by the subscriber (manually) or by the control point automatically. In case of receiving calls or SMS messaging to any of the plurality of subscriber phone numbers it will be converted to a Home MSISDN.

In some embodiments, the multinumbers control point communicates with a subscriber identity module SIM or eSIM having the plurality of subscriber phone numbers associated with the SIM or eSIM in the form of local phone numbers and mobile station international directory numbers (MSISDNs).

In some embodiments, a subscriber device that communicates with a multinumbers control point in a telecommunication system can include a subscriber identity module SIM or eSIM having a plurality of subscriber phone numbers associated with the SIM or eSIM in the form of local phone numbers and mobile station international directory numbers (MSISDNs) where the multinumbers control point at a home network has a corresponding plurality of subscriber phone numbers stored on a memory of the multinumbers control point and one or more processors coupled to the memory having computer instructions that perform certain operations. The operations can include receiving incoming calls (at the subscriber device) by establishing a call by a calling subscriber with a network of a DID provider that leased the dialed MSISDN, where the call is routed by the DID provider to the network of an operator that leased the dialed MSISDN, the operator sends the dialed MSISDN to the multinumbers control point for processing, where the multinumbers control point converts the received subscriber's phone number to their Home MSISDN by the multinumbers control point, and establishing a connection to the subscriber device of the called subscriber corresponding to the called subscriber's International Mobile Subscriber Identity (IMSI) and Home MSISDN.

In some embodiments, the one or more processors are further configured to perform the operations of sending outgoing calls by having a subscriber's operator's network receiving the outgoing call and where an operator sends the outgoing call to the multinumbers control point for processing where the multinumbers control point converts a Home MSISDN into an MSISDN according to rules of the selection process where either automatic number selection or manual number selection by the subscriber is performed according to rules of the selection process, enabling connection to the called party and provision of calling subscriber's phone number to the called party in accordance with the selection process.

### BRIEF DESCRIPTION OF DRAWINGS

The accompanying drawings are incorporated herein and form a part of the specification.

FIG. 1 illustrates a block and flow diagram of a multinumbers technology system for incoming calls in accordance with the embodiments.

FIG. 2 illustrates a block and flow diagram of a multinumbers technology system for outgoing calls in accordance with the embodiments.

FIG. 3 illustrates a block and flow diagram of a multinumbers technology system for incoming SMS messages in accordance with the embodiments.

FIG. 4 illustrates a block and flow diagram of a multinumbers technology system for outgoing SMS messages in accordance with the embodiments.

In the drawings, like reference numbers generally indicate identical or similar elements. Additionally, generally, the left-most digit(s) of a reference number identifies the drawing in which the reference number first appears.

### DETAILED DESCRIPTION

Multinumbers technology is a unique solution that allows subscribers to add and use an unlimited amount of local and international phone numbers (MSISDNs) on a single SIM card/eSIM, which enables every subscriber “to be local” anywhere. All phone numbers (MSISDNs) are always active for calls and SMS, so the subscriber can enjoy communicating, texting, using the internet, and accessing all the apps or applications they need.

The Multinumbers technology empowers subscribers to become “digital world citizens”. By connecting all the international phone numbers (MSISDNs) to a single SIM card/eSIM and setting up notifications, the subscriber can always stay up to date on all their activities in other countries without being tied to a single physical location. The subscriber can stay in contact with their clients, banks, government agencies, new and existing business partners as if they never left their home country. Regardless of what country the subscriber resides in, they can live like a local no matter where they currently reside.

Multinumbers technology can provide unparalleled convenience to subscribers by offering easy access to an unlimited amount of local and international phone numbers. (MSISDNs) on a single SIM card/eSIM. Thus, the Subscriber does not need to change or switch SIM cards/eSIM with a new number every time the Subscriber arrives in a new country or region to make or receive calls or to send or receive SMS messages from foreign contacts, as well as to use data abroad.

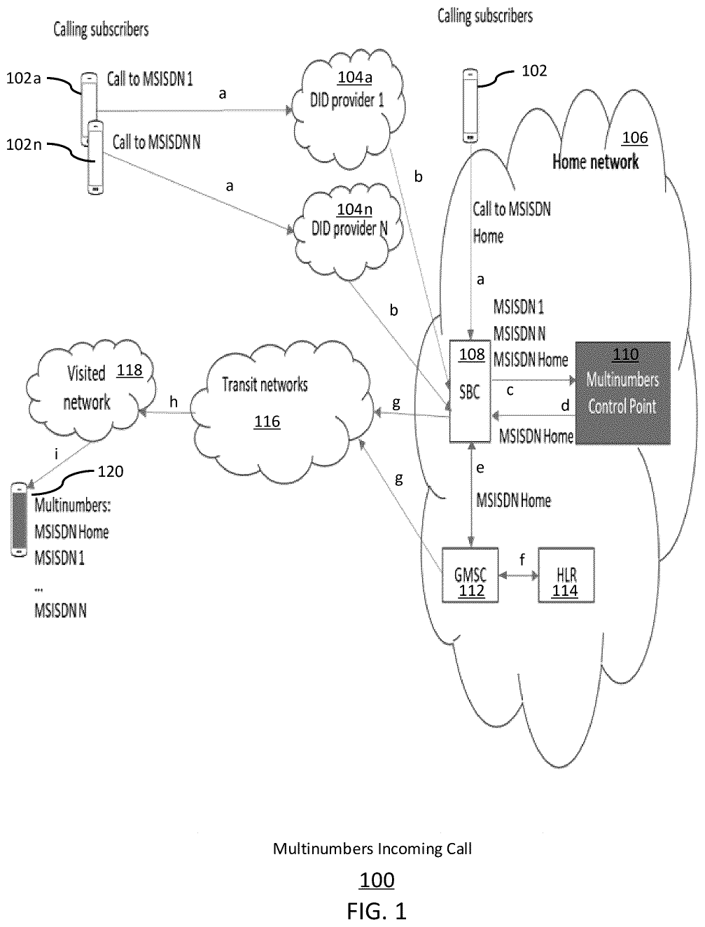

The mechanism of the Multinumbers technology as further detailed below and in FIGS. 1-4 ensures the highest quality of communication, enhances flexibility in communications, eliminates borders between countries, turning one's mobile phone into a truly global digital assistant. This allows any user to enjoy unlimited convenience, saving time and resources.

The innovative Multinumbers solution offers unlimited local and international phone numbers (MSISDNs) and allows users to select their preferred number type for their SIM card/eSIM. These number types include mobile (with SMS support) or landline (without SMS support), geographic (tied to a specific region/city/location in the country) or national (works throughout the country in any region), virtual, or toll-free numbers. If a legal entity subscribes to the service, the wide range of number options provided can enhance the company's reputation and improve customer care.

Multinumbers technology includes essentially an unlimited number of local phone numbers within one country. The subscriber can add an unlimited amount of local numbers in one country. That is, if the subscriber wishes to add more than 2 (two) US numbers, for example, to one SIM card/eSIM, the unique Multinumbers technology allows them to seamlessly use all their connected local numbers for calls and SMS messaging simultaneously.

In some embodiments, the multinumbers technology enables portioning of a local or foreign phone number (Mobile Number Portability). If the subscriber already has local or foreign phone numbers of different countries/regions (MSISDNs), they have an opportunity to transfer and save all their active phone numbers to a single SIM card/eSIM. In that manner, the subscriber keeps in touch with their family and friends, colleagues or business counterparts without changing their usual phone numbers. In some embodiments, keeping the phone number is essential for ensuring seamless access to various services (online banking, shopping, government service portals, etc.).

Some of the benefits of the multinumbers technology includes local presence, comfort, cost savings, access to online services, and flexibility among other. With respect to local presence, the subscriber can stay in contact with his banks, government agencies, new and existing business partners as if he never left their country. No matter where the subscriber is located, a local phone number empowers them to feel at home.

With respect to comfort, the Multinumbers system offers seamless access to an unlimited amount of local and international phone numbers (MSISDN) on a single SIM card/eSIM.

With respect to cost savings, Subscribers can avoid the additional cost of purchasing and using multiple devices or SIM cards with a new local or foreign number when staying in a new country/region or to make/receive calls or SMS from foreign contacts. In addition, the subscriber does not need to set up call forwarding as all local or international numbers (MSISDN) on one SIM card/eSIM are active at the same time.

With respect to having access to online service, having multiple local phone numbers allows the subscriber to simultaneously use multiple social media and messenger accounts on one device.

Multinumbers technology provides flexibility in that it offers access to constantly active local or international numbers (MSISDN) on a single SIM card/eSIM. This enables rapid adaptation to changes in user needs, be it in the business or personal sphere, irrespective of geographic location.

Porting existing international phone numbers to a single SIM card/eSIM enables users to seamlessly access a wide range of services anywhere in the world. This includes receiving SMS messages from foreign banks and accessing various government portals, regardless of the user's location.

By using more than 2 (two) numbers within the same country on a single SIM card/eSIM, subscribers also gain the flexibility to manage their communication efficiently based on different tasks and needs within that country or region. For instance, one local number can be used for personal communication or business correspondence, and the other for any additional services in the country, such as ordering a cab, booking a restaurant, a one-time registration in online services, etc.

Additional opportunities for a legal entity include access to an unlimited amount of international phone numbers (MSISDN), enabling the opening of foreign offices in any country and the establishment of call center operations with foreign representatives. For instance, the groundbreaking Multinumbers technology offers a remarkable opportunity to streamline call center operations by establishing a centralized call reception system for incoming calls to various “foreign representative offices” of the company, even if the entire support staff is located in a single country/city/facility. In addition, the system allows for return calls with the number of the representative office of the country from which the call originally originated.

At the same time, it has a Home MSISDN, which is linked to the IMSI of its SIM card/eSIM, and it is used by the subscriber to register in the visited networks.

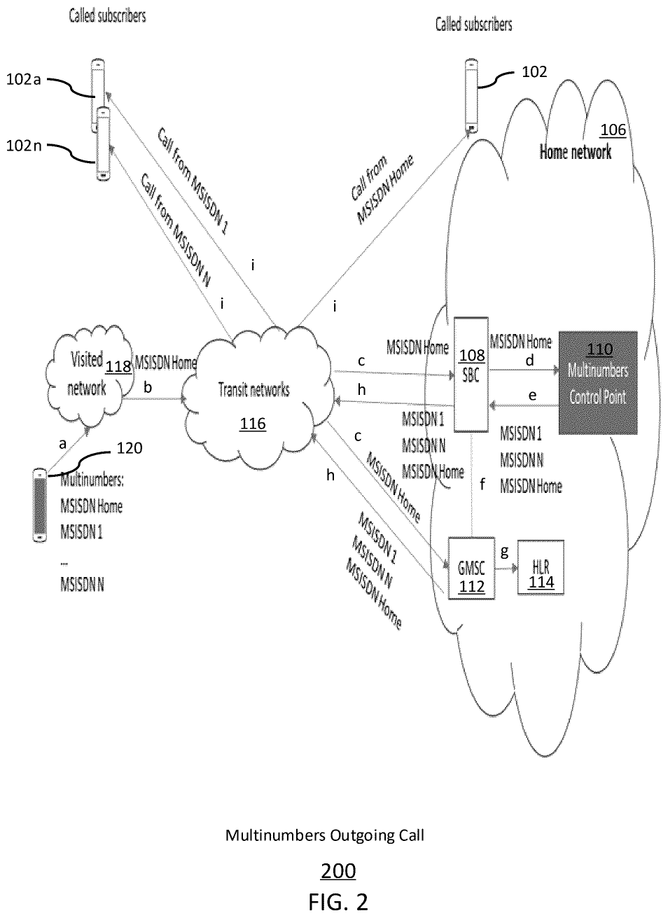

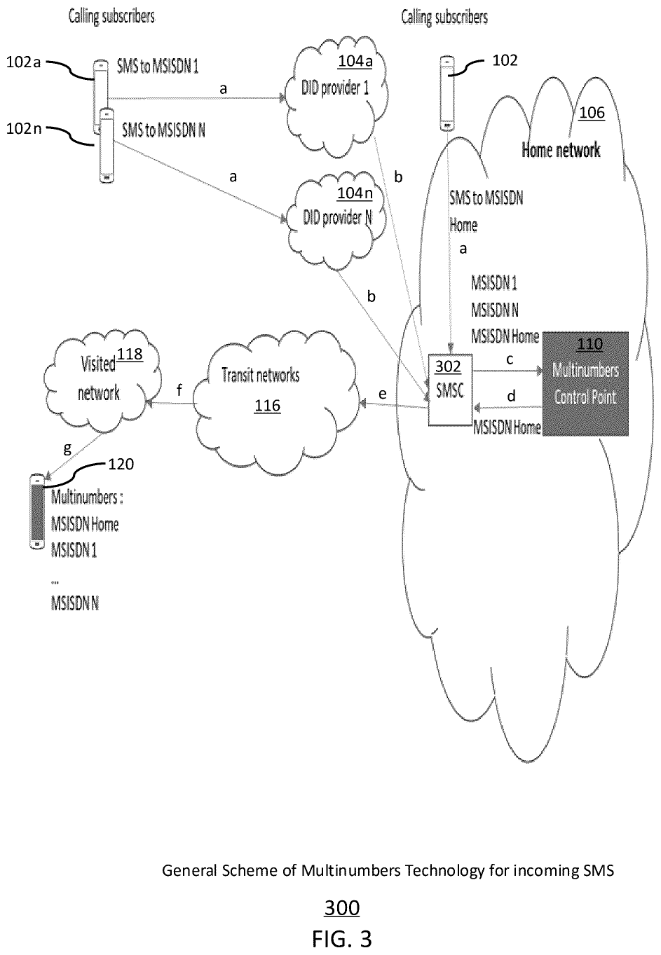

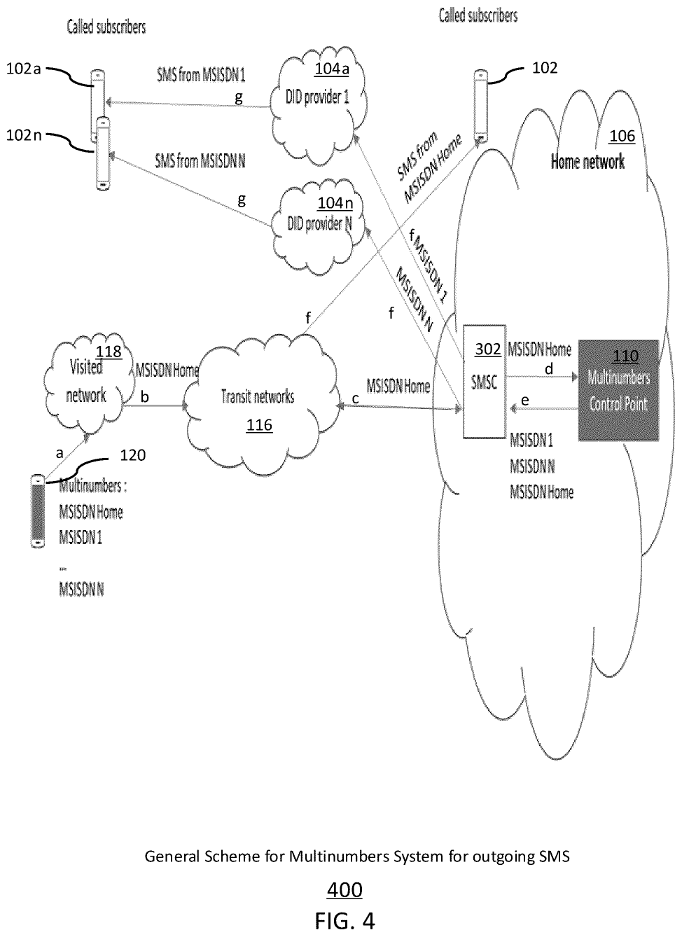

Referring to FIGS. 1-4, Multinumbers technology can be implemented by storing the list of phone numbers purchased by the subscriber in the central part of a system (100, 200, 300 or 400) at a Multinumbers Control Point 110. The flow of information, calls or SMS messages will generally follow the order of a through i in FIG. 1, a through i in FIG. 2, a through g in FIG. 3 and a through g in FIG. 4.

In a system 100 where a subscriber device 120 (having multiple MSISDNs associated with a SIM or eSIM) as a called party can receive an incoming call from a calling party (among 102, 102a through 102n) by establishing a call with a network of a DID provider (among 104a through 104n) that leased the dialed MSISDN, routing the call by the DID provider to the network of an operator that leased the dialed MSISDN, sending the dialed MSISDN by the operator to the multinumbers control point 110 (via an SBC 108 of a Home network 106) for processing, converting the received subscriber's phone number to their Home MSISDN by the multinumbers control point 110, and establishing a connection to the called subscriber 120 corresponding to the called subscriber's International Mobile Subscriber Identity (IMSI) and Home MSISDN. In some embodiments, the connection is established to the called subscriber 120 via transit networks 116 and a visited network 118 as illustrated in FIG. 1. In some embodiments a calling subscriber such as a calling subscriber 102, 102a, or 102n can have a call and information routed via an SBC 108 to the Multinumber Control Point 110. The Multinumber Control Point 110 defines the Home MSISDN, then the call is routed to a GSMC 112 which provides access to the HLR 114, where the HLR 114 provides to the GMSC a called party location. According this location, the call is routed to the appropriate called party visited network via the transit networks 116. Transit network can be connected via SBC 108 or via GMSC 112 depending on the protocol used by transit network 116. From the transit network 116, calls are routed to the visited network 118, and ultimately to the called subscriber 120 as shown.

The selection of the phone number to be provided to the called party is done either automatically by the central part of the system (Multinumbers Control Point 110) or in a manual mode.

In some embodiments, the one or more processors of the multinumbers control point 110 can be further configured to perform the operations of sending outgoing calls by subscriber 120 as illustrated in the system 200 of FIG. 2 by receiving an outgoing call in a subscriber's operator's network (via a visited network 118, transit networks 116, and SBC 108) where an operator sends the outgoing call to the multinumbers control point 110 for processing where the multinumbers control point 110 converts a Home MSISDN into an MSISDN according to rules of the selection process where either automatic number selection or manual number selection by the subscriber is performed according to rules of the selection process, connecting the called party (among 102 and 102a through 102n) (via the transit networks 116), and providing the phone number of the calling subscriber 120 in accordance with the selection process. Routing of calls and information can be from the visited network of the calling party to the transit networks 116, then to the SBC 108 or GMSC 112 depending on the transit network protocols and then to the Multinumber Control Point 110. The Multinumber Control Point 110 sets an appropriate MSISDN for the calling subscriber and then the call is routed to the GMSC 112. The GMSC 112 provides access to the HLR 114 to get information about the called party location and based on this location, the call is routed via the GMSC or SBC via the transit network to the called party as shown in FIG. 2.

FIGS. 3 and 4 illustrate operational flows for incoming SMS messaging and outgoing SMS messaging respectively which will operate similarly to the routing of calls and information as in FIGS. 1 and 2 respectively. In some embodiments, a system 300 using multinumbers technology as shown in FIG. 3 can receive at a subscriber device 120 incoming SMS messages by having a calling subscriber (any of 102a through 102n) send a SMS message via a network of a DID provider (104a through 104n respectively) that leased the dialed MSISDN, routing the SMS message by the DID provider to the network of an operator that leased the dialed MSISDN, sending the dialed MSISDN by the operator (via an SMSC 302 of a home network 106) to the multinumbers control point 110 for processing, converting the received subscriber's phone number to their Home MSISDN by the multinumbers control point 110, and establishing a connection to the called subscriber 120 corresponding to the called subscriber's International Mobile Subscriber Identity (IMSI) and Home MSISDN. In any case, the SMSC 302 or Short Message Service Center can send the SMS message to the called subscriber 120 via transit networks 116 and visited network 118 as shown. In some embodiments, the calling subscriber 120 in their home network will have SMS messages routed via the SMSC without the use of a DID provider as shown in FIG. 3.

In some embodiments, a system 400 using the multinumbers technology as shown in FIG. 4 can have a calling subscriber 120 send outgoing SMS messages by receiving an outgoing SMS message in a subscriber's operator's network where an operator sends the outgoing SMS message to the multinumbers control point 110 for processing where the multinumbers control point 110 converts a Home MSISDN into an MSISDN according to rules of a selection process where either automatic number selection or manual number selection by the subscriber is performed according to rules of the selection process, connecting the called party (any of 102a, 102n or 102), and providing the phone number of the SMS messaging subscriber 120 in accordance with the selection process.

In any of the embodiments, the Multinumbers Control Point 110 can provide automatic selection of the calling subscriber's phone number in case the subscriber has a phone number corresponding to the country of the called party. In some embodiments, if the subscriber does not have a phone number corresponding to the country of the called party, transmission of the number can be selected by the subscriber while establishing a connection or sending an SMS message. The multinumbers control point 110 can also provide conversion of the subscriber's purchased phone numbers to his primary phone number Home MSISDN. This is required to receive calls and SMS messages to any of the subscriber's numbers.

Referring again to FIG. 1, the calling subscriber (102a, 102n, or 102) dials one of the phone numbers of the subscriber 120 with multiple MSISDN and the call is established to the network of the DID provider (104a, 104n or 106) that leased the dialed MSISDN.

The DID provider then routes the call to the network of the operator that leased the relevant MSISDN. The operator (106), having received the call from the DID provider, sends it to the Multinumbers Control Point 110 for processing.

The Multinumbers Control Point 110 converts the received subscriber's phone number into their Home MSISDN and establishes a connection to the called subscriber 120 in line with their registration based on IMSI and Home MSISDN.

In the case of establishing an outgoing connection from a subscriber (120) having multiple MSISDNs as shown in the system 200 of FIG. 2, the call is received in the operator's network of the subscriber and the operator sends it to the Multinumbers Control Point 110 at a Home network 106 of the calling subscriber 120 for processing.

Multinumbers Control Point 110 converts Home MSISDN into an MSISDN according to the rules of automatic number selection or according to the rules of manual number selection by the subscriber (120).

Then the connection to the called subscriber (102a, 102n, or 102) is established and the phone number of the calling subscriber 120 is provided in accordance with the rules described earlier.

Again, FIGS. 3 and 4 show the mechanisms for receiving and sending SMS for the subscriber with multiple MSISDNs. The process is similar to establishing voice connections as previously shown with respect to FIGS. 1 and 2.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a small cell networking device may be described as being mounted “substantially vertical,” In these cases, a device that is mounted exactly vertical is mounted along a “Y” axis and a “X” axis that is normal (i.e., 90 degrees or at right angle) to a plane or line formed by a “Z” axis. Different from the exact precision of the term, “vertical,” and the use of “substantially” or “about” to modify the characteristic permits a variance of the particular characteristic by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device may be transformed from a generic and unspecific computing device to a combination device comprising hardware and software configured for a specific and particular purpose. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and abstract provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide yet further embodiments.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed:

1. A multinumbers technology management system, comprising:
a multinumbers control point in a home network;
a plurality of subscriber phone numbers stored on a memory of the multinumbers control point; and
one or more processors coupled to the memory having computer instructions, the one or more processors configured to execute computer instructions to perform the operations of:
automatically selecting or manually selecting a calling subscriber's phone number corresponding to a phone number of a called party's country in a selection process;
transmitting a phone number selected by the subscriber while establishing a connection to a called party or sending an SMS to a called party;
if a subscriber does not have a phone number stored in the multinumbers control point corresponding to the called party's country, then using a default number; and
converting the subscriber's phone numbers to a primary phone number Home MSISDN if receiving calls or SMS messages at any of the plurality of subscriber phone numbers.

2. The multinumbers technology management system of claim 1, wherein the multinumbers technology management system further includes a subscriber identity module SIM or eSIM having the plurality of subscriber phone numbers associated with the SIM or eSIM.

3. The multinumbers technology management system of claim 2, wherein the the plurality of subscriber phone numbers are local phone numbers and international phone numbers.

4. The multinumbers technology management system of claim 2, wherein the the plurality of subscriber phone numbers associated with the SIM or eSIM are local phone numbers and mobile station international directory numbers (MSISDNs) and the default number is a MSISDN.

5. The multinumbers technology management system of claim 1, wherein the plurality of subscriber phone numbers are always active for calls and SMS messages.

6. The multinumbers technology management system of claim 1, wherein the multinumbers technology management system enables subscribers to select their preferred number type for their SIM card/eSIM.

7. The multinumbers technology management system of claim 6, wherein the number types include mobile phone numbers with SMS support, landline phone numbers without SMS support, geographic-based phone numbers tied to a specific region, city, or location in a country, geographic-based national phone numbers that work throughout a country in any region of the country, virtual phone numbers, or toll-free numbers.

8. The multinumbers technology management system of claim 1, wherein the one or more processors enable the subscriber to add two or more phone numbers for a given country or region to the SIM or eSIM to enable seamless use of connected local phone numbers for calls and SMS messages simultaneously.

9. The multinumbers technology management system of claim 1, wherein the one or more processors enable the subscriber to transfer and save all active phone numbers to a single SIM card/eSIM if the subscriber already has local or foreign phone numbers of different countries or regions (MSISDN).

10. The multinumbers technology management system of claim 1, wherein the subscriber receives all calls at a subscriber device having the subscriber identity module SIM or eSIM having the plurality of subscriber phone numbers associated with the SIM or eSIM without setting up call forwarding since the plurality of subscriber phone numbers are all active at the same time.

11. The multinumbers technology management system of claim 1, wherein the one or more processors enables the subscriber to simultaneously use multiple social media and messenger accounts on a subscriber device having the subscriber identity module (SIM) or eSIM having the plurality of subscriber phone numbers associated with SIM or eSIM.

12. The multinumbers technology management system of claim 1, wherein the plurality of subscriber phone numbers are purchased by a subscriber.

13. The multinumbers technology management system of claim 1, wherein the one or more processors are further configured to perform the operations of receiving incoming calls by establishing a call with a network of a DID provider that leased the dialed MSISDN, routing the call by the DID provider to the network of an operator that leased the dialed MSISDN, sending the dialed MSISDN by the operator to the multinumbers control point for processing, converting the received subscriber's phone number to their Home MSISDN by the multinumbers control point, and establishing a connection to the called subscriber corresponding to the called subscriber's International Mobile Subscriber Identity (IMSI) and Home MSISDN.

14. The multinumbers technology management system of claim 1, wherein the one or more processors are further configured to perform the operations of sending outgoing calls by receiving an outgoing call in a subscriber's operator's network where an operator sends the outgoing call to the multinumbers control point for processing where the multinumbers control point converts a Home MSISDN into an MSISDN according to rules of the selection process where either automatic number selection or manual number selection by the subscriber is performed according to rules of the selection process, connecting the called party, and providing the phone number of the calling subscriber in accordance with the selection process.

15. The multinumbers technology management system of claim 1, wherein the one or more processors are further configured to perform the operations of receiving incoming SMS messages by establishing a SMS message with a network of a DID provider that leased the dialed MSISDN, routing the SMS message by the DID provider to the network of an operator that leased the dialed MSISDN, sending the dialed MSISDN by the operator to the multinumbers control point for processing, converting the received subscriber's phone number to their Home MSISDN by the multinumbers control point, and establishing a connection to the called subscriber corresponding to the called subscriber's International Mobile Subscriber Identity (IMSI) and Home MSISDN.

16. The multinumbers technology management system of claim 1, wherein the one or more processors are further configured to perform the operations of sending outgoing SMS messages by receiving an outgoing SMS message in a subscriber's operator's network where an operator sends the outgoing SMS message to the multinumbers control point for processing where the multinumbers control point converts a Home MSISDN into an MSISDN according to rules of the selection process where either automatic number selection or manual number selection by the subscriber is performed according to rules of the selection process, connecting the called party, and providing the phone number of the SMS messaging subscriber in accordance with the selection process.

17. A multinumbers control point in a telecommunication system, comprising:
a plurality of subscriber phone numbers stored on a memory of the multinumbers control point at a home network; and
one or more processors coupled to the memory having computer instructions, the one or more processors configured to execute computer instructions to perform the operations of:
automatically selecting or manually selecting a calling subscriber's phone number corresponding to a phone number of a called party's country in a selection process;
transmitting via a session border controller a phone number selected by the subscriber while establishing a connection to a called party or sending via a short message service center an SMS to a called party
if a subscriber does not have a phone number stored in the multinumbers control point corresponding to the called party's country, then using a default number; and
converting the subscriber's phone numbers to a primary phone number Home MSISDN if receiving calls or SMS messages at any of the plurality of subscriber phone numbers.

18. The multinumbers control point of claim 17, wherein the multinumbers control point communicates with a subscriber identity module SIM or eSIM having the plurality of subscriber phone numbers associated with the SIM or eSIM in the form of local phone numbers and mobile station international directory numbers (MSISDNs).

19. A subscriber device that communicates with a multinumbers control point in a telecommunication system, comprising:
a subscriber identity module SIM or eSIM having a plurality of subscriber phone numbers associated with the SIM or eSIM in the form of local phone numbers and mobile station international directory numbers (MSISDNs) wherein the multinumbers control point at a home network has a corresponding plurality of subscriber phone numbers stored on a memory of the multinumbers control point; and
one or more processors coupled to the memory having computer instructions, the one or more processors configured to execute computer instructions to perform the operations of:
receiving incoming calls by establishing a call by a calling subscriber with a network of a DID provider that leased the dialed MSISDN, wherein the call is routed by the DID provider to the network of an operator that leased the dialed MSISDN, the operator sends the dialed MSISDN to the multinumbers control point for processing, wherein the multinumbers control point converts the received subscriber's phone number to their Home MSISDN by the multinumbers control point, and establishing a connection to the subscriber device of the called subscriber corresponding to the called subscriber's International Mobile Subscriber Identity (IMSI) and Home MSISDN.

20. The subscriber device of claim 19, wherein the one or more processors are further configured to perform the operations of sending outgoing calls by having a subscriber's operator's network receiving the outgoing call and wherein an operator sends the outgoing call to the multinumbers control point for processing where the multinumbers control point converts a Home MSISDN into an MSISDN according to rules of the selection process where either automatic number selection or manual number selection by the subscriber is performed according to rules of the selection process, enabling connection to the called party and provision of calling subscriber's phone number to the called party in accordance with the selection process.
